(19) United States
(12) Patent Application Publication
(10) Pub. No.: US 2014/0005820 A1
(43) Pub. Date: Jan. 2, 2014

(54) CONTROLLING A BATTERY-OPERATED HANDHELD POWER TOOL

(71) Applicant: Heiko ROEHM, Stuttgart (DE)

(72) Inventor: Heiko ROEHM, Stuttgart (DE)

(73) Assignee: Robert Bosch GmbH, Stuttgart (DE)

(21) Appl. No.: 13/927,262

(22) Filed: Jun. 26, 2013

(30) Foreign Application Priority Data
Jun. 29, 2012 (DE) 10 2012 211 342.8
Feb. 28, 2013 (DE) 10 2013 203 397.4

(51) Int. Cl. G05B 11/01

(52) U.S. Cl. CPC G05B 11/01
USPC 700/168

(57) ABSTRACT

A method for controlling an operation of an electrical handheld power tool having a drive motor and an electrical energy store includes the step of determining that a parameter of the handheld power tool is beyond a threshold value and the step of controlling the drive motor in such a way that a torque output thereby periodically oscillates between a first and a second value, a frequency of the oscillation being below an audible range.

### FIELD OF THE INVENTION

The present invention relates to controlling a battery-operated handheld power tool. In particular, the present invention relates to a method and a device for outputting haptic feedback of a battery-operated handheld power tool to a user.

### BACKGROUND INFORMATION

A handheld power tool is supplied with electrical power from a chargeable electrical energy store. The electrical energy store may, in particular, include a number of nickel-metal hydride cells or lithium ion cells. Such cells require compliance with certain electrical and physical parameters in order to ensure their capacity and to reduce an accident hazard, e.g., caused by leakage, bursting, or explosion. A common electrical battery therefore includes a control unit for determining one or multiple parameter(s).

If one of the determined parameters exceeds or falls below a predetermined threshold value or if the combination of the present parameters indicates that a further discharging of the battery may result in an accident hazard or damage, the control unit may turn off the battery or output a message to another control element in the handheld power tool so that this control element changes or terminates the energy withdrawal from the battery. In some specific embodiments, a visual or an acoustic output device is provided on the side of the battery or of the handheld power tool in order to output a corresponding warning to a user of the handheld power tool. After receiving the warning, the user is able to change his/her mode of operation, e.g., in the form of operating speed, and to thus enable at least a limited operation of the handheld power tool.

A visual or acoustic signal, however, does not necessarily get through to the user while he/she is using the electrical handheld power tool. An acoustic signal may get lost among ambient or operating noises and a visual signal may, for example, go unnoticed by the user, who is focused on his/her workpiece, due to lighting conditions. Moreover, the provision of an acoustic or visual output element is associated with additional costs.

United States Published Patent Appln. No. 2008/0180059 shows techniques for protection against error conditions in a battery of an electrically operated power tool. The evaluated error conditions include an overcharging, a total discharge, an overcurrent, and an overtemperature of a battery. To warn a user against such an error condition, a pulse-width modulating speed control of the electric drive motor is operated in such a way that an audible twittering effect results.

It is an object of the present invention to provide an improved technique for outputting a warning to a user of an electrically operable handheld power tool, if the electrical capacity of an electrical energy store is limited.

### SUMMARY

A method according to the present invention for controlling an operation of an electrical handheld power tool having a drive motor and an electrical energy store includes the step of determining that a parameter in the handheld power tool is beyond a threshold value and the step of controlling the drive motor in such a way that a torque output thereby periodically oscillates between a first and a second value, a frequency of the oscillation being below an audible range.

According to the present invention, a tactile or haptic signal is output to a user of the handheld power tool, when the determined parameter indicates a predetermined warning state. The warning state may, in particular, include an existing or impending limited capacity of the electrical energy store, an impending switch off due to a torque or impending thermal damage to a component of the handheld power tool. In addition, a current, a voltage, or a temperature of the drive motor or of the energy store may, in particular, be included in the parameter. The tactile or haptic output may raise the attention of the user directly to the present state of the handheld power tool, without using an acoustic or visual channel which is prone to interferences in practice. In particular, by selecting the frequency of the oscillation to be below an audible range, the acoustic channel may remain unused, whereby the direct indication to an issue with the handheld power tool may be supported.

In one preferred specific embodiment, the first value of the output torque corresponds to a torque preselectable by a user, and the second value is smaller than the first value. In other words, a user-defined torque input may be periodically fallen below to indicate the present state of the handheld power tool to the user. In this way, the user is able to finish a process step which he/she is carrying out with the aid of the handheld power tool, while a conspicuous warning signal is simultaneously provided by the periodically limited power of the drive motor.

The second value preferably corresponds to zero. The drive motor may therefore be switched on and off periodically, in order to ensure further usability of the handheld power tool, while the haptic or tactile signal is generatable in an easy and reliable manner.

In one specific embodiment, the values for the torque may be set in such a way that a difference between the values is a function of a difference between the parameter and the threshold value. If the determined parameter, for example, moves further and further away from the threshold value during operation of the handheld power tool, the torque oscillations of the drive motor may increase as a response thereto. In this way, an urgency of the alarm or warning signal may be conveyable to the user.

In another specific embodiment, which may also be combined with the aforementioned specific embodiment, the frequency may be varied as a function of a difference between the parameter and the threshold value. Here, the frequency may be reduced or increased with an increasing distance of the parameter from the threshold value.

In another preferred specific embodiment, the method furthermore includes setting the first and the second values in such a way that a mean value of the output torque corresponds to zero if the parameter approximates a predetermined value beyond the threshold value. The predetermined value may be formed by another, second, threshold value which is at a distance from the first threshold value. Effectively, the handheld power tool may generate a more or less strong vibration, the usability for the originally intended purpose being practically eliminated.

In this way, the warning or alarm signal may be implemented very clearly, while an electrical load on the energy store is significantly reduced.

After a predetermined time period, after the threshold value has passed through the parameter, the values may be equated with one another. In this way, the vibrations of the handheld power tool may be reset after a predetermined time period. This makes it possible to transfer the decision-making process to the user, as to whether or not a process step should be continued under the existing circumstances. In particular in cases in which an interruption of a process step may result in a worse work product, the failure of the process step due to the output warning signal may be prevented in this way.

If the parameter is beyond the threshold value by a predetermined value, the drive motor may also be switched off In this way, a third threshold value may be implemented; if this threshold value is exceeded the operation of the handheld power tool is automatically discontinued for safety reasons. The operational safety of the handheld power tool may thus be ensured.

An electrical computer program product according to the present invention includes program code for carrying out the described method when the computer program product is executed on a processing device or is stored on a computer-readable data carrier.

A handheld power tool according to the present invention includes an electrical energy store, a drive motor for being operated from the electrical energy store, and a control unit for determining that a parameter in the handheld power tool is beyond a threshold value and for controlling an operation of the drive motor in such a way that a torque output by the drive motor periodically oscillates between a first and a second value, a frequency of the oscillation being below an audible range.

The handheld power tool may contribute to maintaining at least partially a productivity of a user even in the presence of a disturbance or a reduced capacity of the electrical energy store.

### BRIEF DESCRIPTION OF THE DRAWINGS

FIG. 1 shows an electrical handheld power tool.

FIG. 2 shows a flow chart of a method for controlling the handheld power tool from FIG. 1.

### DETAILED DESCRIPTION

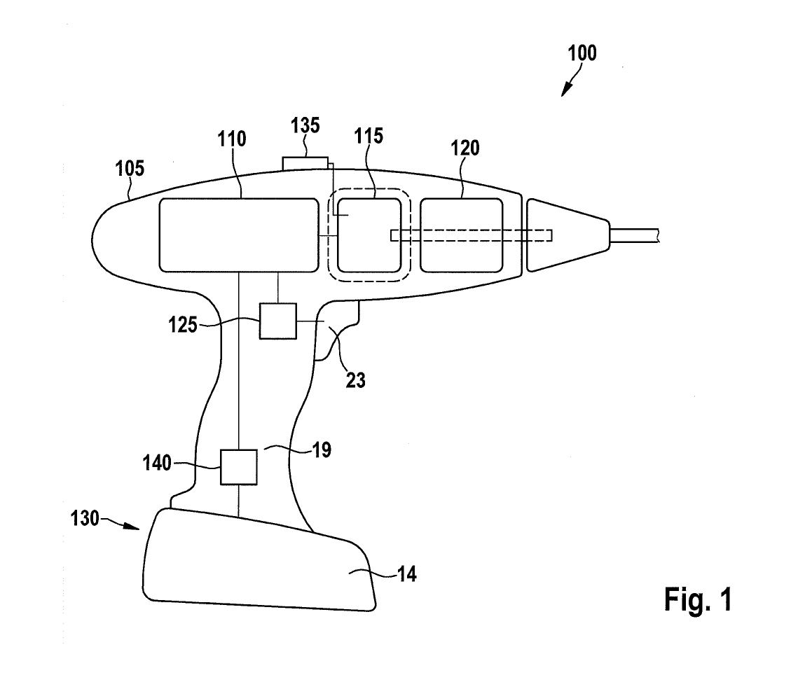

FIG. 1 shows an electrical handheld power tool 100. In the present, exemplary specific embodiment, handheld power tool 100 is a cordless screwdriver, in particular; in other specific embodiments, it may, however, also be an electric jigsaw or other electrically operable equipment, for example.

Handheld power tool 100 includes a housing 105 in which a control unit 110, a drive motor 115, an optional gear 120, and an operating switch 125 are situated. An energy store 130 is attached to or within housing 105, energy store 130 preferably being replaceable without opening housing 105.

Control unit 110 is configured to control drive motor 115 as a function of a signal of operating switch 125. In one preferred specific embodiment, operating switch 125 is configured to support multiple different stages in order to operate drive motor 115 at different speeds. In one preferred specific embodiment, a dial element 135 is provided to predefine a maximum torque which may be output by handheld power tool 100.

A monitoring device 140 is provided for determining and, if necessary, interlinking one or multiple parameters in handheld power tool 100. Monitoring device 140 may be part of control unit 110 or of energy store 130 which is removable from handheld power tool 100. Monitoring device 140 may, for example, detect the voltages of individual energy cells of energy store 130, a total voltage of energy store 130, the temperatures of at least one component of handheld power tool 100 (e.g., of an energy cell of energy store 130, of drive motor 115, of a MOSFET of control unit 110, etc.), a total temperature or a current of energy store 130 and/or of drive motor 115. In one specific embodiment, monitoring device 140 is configured to electrically disconnect energy store 130 from the handheld power tool when the determined parameters indicate a state of energy store 130 in which further electrical energy withdrawal could result in permanent damage or endangerment of the surroundings.

Control unit 110 is configured to compare a parameter of monitoring device 140 to a predetermined threshold value and to activate drive motor 115 as a function of the comparison in such a way that during the operation of handheld power tool 100, an output torque is subjected to a low-frequency oscillation in order to make a user of handheld power tool 100 aware of the state of the determined parameter.

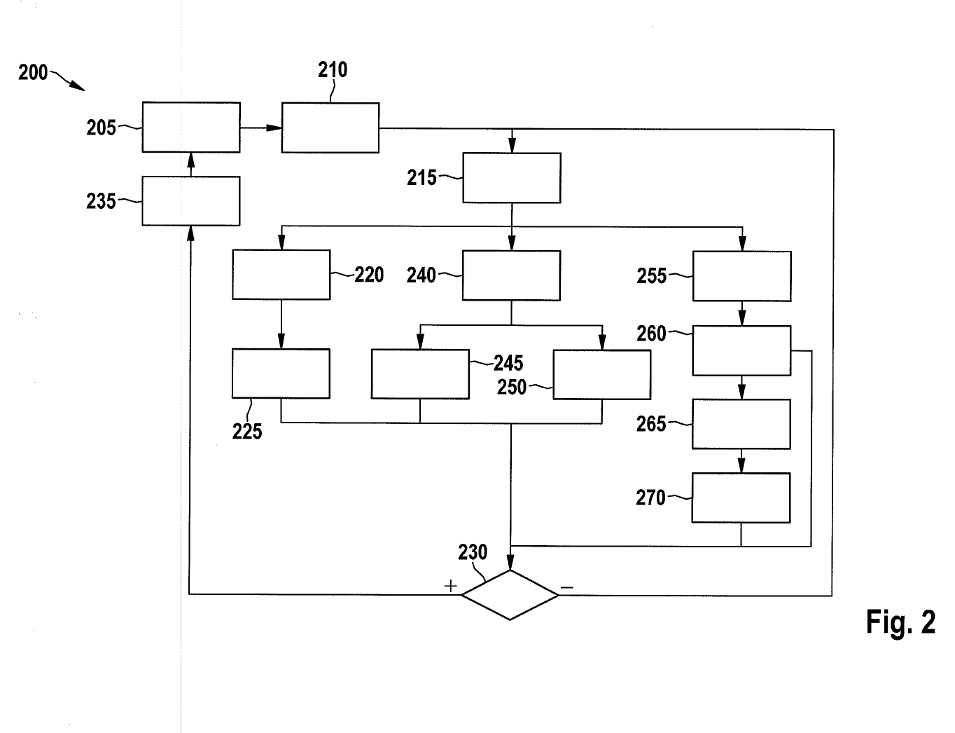

FIG. 2 shows a flow chart of a method 200 for controlling handheld power tool 100 from FIG. 1. Method 200 is in particular configured to be carried out by control unit 110. Control unit 110 may include a programmable microcomputer, it being possible for method 200 to be implemented in the form of a computer program product.

Method 200 starts in a step 205 in which drive motor 115 is switched off. In a subsequent step 210, it is determined that operating switch 125 is activated. Subsequently, a parameter is determined which indicates an electrical load on electrical energy store 130. For example, the electrical parameter may represent a current or a temperature in handheld power tool 100 as described above with reference to monitoring device 140 in handheld power tool 100 from FIG. 1. It is assumed that the higher the parameter, the less efficient is energy store 130 or the less urgent it is to terminate further energy withdrawal from energy store 130 in order to avoid an overload of energy store 130.

To form the parameter, a sampled value may be prepared accordingly, e.g., when a temperature is determined on the basis of a voltage of an NTC. In this case, the parameter may be determined from the value with the aid of a negative scaling factor, in order to effectuate the assignment of a high parameter to a small capacity. In another specific embodiment, a high parameter reversely indicates a high capacity of energy store 130.

In the following, the determined parameter is compared to one or multiple threshold values S1, S2, S3, or S4, it being assumed here without the limitation of generality that the following applies: S1<S2<S3<S4.

If the determined parameter is below first threshold value S1, this indicates an undiminished capacity of electrical energy store 130. This state may be understood as a normal operation. If the parameter is above first threshold value S1, multiple different cases may be differentiated. In simpler specific embodiments, the determination of one or multiple of the cases described in the following may, however, also be dispensed with.

In a first case, which is illustrated by a step 220, the determined parameter is above first threshold value S1, but still below second threshold value S2. In this case, drive motor 115 is activated in a subsequent step 225 to output a torque which oscillates periodically between the two values W1 and W2. In one specific embodiment, one of values W1, W2 may correspond to zero. The oscillation frequency is in this case below a range audible for humans, but within the tactilely perceivable range, e.g., below approximately 10 Hz and above approximately 1 Hz. Method 200 continues in a step 230 to check whether operating switch 125 has been deactivated. If this is not the case, method 200 returns to step 215 and passes through it again. As long as the determined parameter is between threshold values Si and S2, method 200 passes through the branch of steps 220 and 225, the low-frequency oscillation of the torque being maintained.

If operating switch 125 is, however, deactivated in step 230, drive motor 110 may be switched off directly in a step 235 or after a phase of post vibrations has elapsed. Subsequently, method 200 may be restarted starting from step 205.

In a second case, which is illustrated by a step 240, the determined parameter is between threshold values S2 and S3. In a first variant of method 200, the frequency of the torque oscillation of branches 220 and 225 is changed in a step 245 depending on by how much the determined parameter exceeds second threshold value S2 or how far away the parameter is from third threshold value S3. If the parameter increases between threshold values S2 and S3, the frequency of the torque oscillation may therefore increase or drop.

In another variant, which may be combined with the afore-named variant from step 245, values W1 and W2 are set in a step 250 closer to one another or farther away from one another as a function of the distance of the determined parameter from one of threshold values S2 or S3. In the case of an increased distance of values W1 or W2, a noticeable amplitude of the torque oscillation may be greater, while the amplitude may be smaller in the case of a smaller distance between W1 and W2.

Each of steps 245, 250 is followed by the above-described check in step 230, and method 200 may restart. Here, the branch of steps 240, 245, or 250 is passed through, while the determined parameter is between threshold values S2 and S3.

In a third case, which is represented by a step 255, the determined parameter is above third threshold value S3. Consequently, values W1, W2 are set in a step 260 in such a way that a medium torque, output by drive motor 115, has the value zero. In other words, drive motor 115 may be activated alternatingly in different directions of rotation. A rotary motion output by handheld power tool 100 is generally no longer useful in a process step for which handheld power tool 100 is configured, so that in this way an urgent indication of overload may be output to the user.

Method 200 may proceed to step 230 starting from step 260 and, if necessary, pass through it again, as explained above. In another specific embodiment, drive motor 115 may continue to be operated in the described manner in a step 265 until a predetermined time period has elapsed, e.g., 10 seconds. If operating switch 125 has not been deactivated until then, drive motor 115 may be switched off in a step 270. In another specific embodiment, drive motor 115 may also be switched off directly after exceeding third threshold value S3 or a fourth threshold value S4 which is above third threshold value S3.

It is not necessary to implement all illustrated steps 205 through 270 of method 200. For example, it may be sufficient to only implement one or two of the illustrated paths which follow step 215. In other specific embodiments, a sequence of steps 205 through 270 may be varied, as those skilled in the art will easily recognize.

What is claimed is:

1. A method for controlling an operation of an electrical handheld power tool including a drive motor and an electrical energy store, comprising:
determining that a parameter in the handheld power tool is beyond a threshold value; and
controlling the drive motor in such a way that a torque output by the torque motor undergoes a periodic oscillation between a first value and a second value, wherein a frequency of the oscillation is below an audible range.

2. The method as recited in claim 1, wherein:
the first value corresponds to a torque preselectable by a user, and
the second value is smaller than the first value.

3. The method as recited in claim 2, wherein the second value corresponds to zero.

4. The method as recited in claim 1, further comprising:
setting the first and second values for the periodic oscillation in such a way that a difference between the first and the second values is a function of a difference between the parameter and the threshold value.

5. The method as recited in claim 1, further comprising:
changing the frequency as a function of a difference between the parameter and the threshold value.

6. The method as recited in claim 1, further comprising:
setting the first and the second values for the periodic oscillation in such a way that a mean value of the output torque corresponds to zero if the parameter approximates a predetermined value beyond the threshold value.

7. The method as recited in claim 1, further comprising:
equating the first and the second values for the periodic oscillation after a predetermined time period after the threshold value has passed through the parameter.

8. The method as recited in claim 1, further comprising:
switching off the drive motor after determining that the parameter is beyond the threshold value by a predetermined value.

9. A computer program product having a program code for carrying out a method for controlling an operation of an electrical handheld power tool including a drive motor and an electrical energy store, the method comprising:
determining that a parameter in the handheld power tool is beyond a threshold value; and
controlling the drive motor in such a way that a torque output by the torque motor undergoes a periodic oscillation between a first value and a second value, wherein a frequency of the oscillation is below an audible range, and wherein the computer program product one of is executed on a processing unit and is stored on a computer-readable data carrier.

10. An electrical handheld power tool, comprising:
an electrical energy store;
a drive motor that is operated from the electrical energy store; and
a control unit for determining that a parameter in the handheld power tool is beyond a threshold value, and for controlling the drive motor in such a way that a torque output by the drive motor undergoes a periodic oscillation between a first value and a second value, a frequency of the oscillation being below an audible range.
